(19) United States
(12) Patent Application Publication
(10) Pub. No.: US 2018/0373896 A1
(43) Pub. Date: Dec. 27, 2018

(54) TECHNIQUES TO PROVIDE GRANULAR CONTROL FLOW ENFORCEMENT

(71) Applicant: INTEL CORPORATION, SANTA CLARA, CA (US)

(72) Inventor: RODRIGO R. BRANCO, Hillsboro, OR (US)

(73) Assignee: INTEL CORPORATION, SANTA CLARA, CA (US)

(21) Appl. No.: 15/634,107

(22) Filed: Jun. 27, 2017

(51) Int. Cl. G06F 21/71

(52) U.S. Cl. CPC G06F 21/71; G06F 9/3005

(57) ABSTRACT

Various embodiments are generally directed to an apparatus, method and other techniques to detect an attempt of an indirect flow instruction to redirect processing flow to instructions comprising a flow marker instruction, determine that the flow marker instruction includes a parameter, and determine whether the indirect flow instruction is from one of a valid source and an invalid source based on a source marker matching the parameter. Embodiments include causing an exception if the indirect flow instruction is an invalid source and permitting the attempt to redirect the processing flow by the indirect flow instruction if the indirect flow instruction is a valid source.

### TECHNICAL FIELD

Embodiments described herein generally include techniques to provide granular control enforcement to prevent redirection attacks.

### BACKGROUND

A computer system typically includes a number of hardware components including a processor to process instructions and information. The instructions inevitably include vulnerabilities that may be exploited by attackers trying to gain control of a system. These attacks include call-oriented programming (COP) attacks and jump-oriented programming (JOP) attacks. The attacks have common elements, such as diverting control flows, e.g. call instructions and jump instructions, from its original target address to a new target. Embodiments discussed herein are directed to preventing these attacks and solving other problems.

### BRIEF DESCRIPTION OF THE DRAWINGS

FIG. 1 illustrates an example embodiment of a device.

FIG. 2 illustrates an example of a first logic flow.

FIG. 3AB illustrates examples of instructions.

FIG. 4 illustrates an example of a page table.

FIG. 5 illustrates an example of a second logic flow.

FIG. 6 illustrates an example embodiment of a first computing architecture.

FIG. 7 illustrates an example embodiment of a device.

### DETAILED DESCRIPTION

Various embodiments may generally be directed to preventing code redirection attacks by ensuring that a redirection of a processing flow is made by a valid source. For example, embodiments may include determining that a call instruction (CALL) or jump instruction (JMP) is executing or about to be executed and is attempting to redirect processing flow to another instruction or set of instructions which includes a flow marker instruction. Embodiments also include determining that the flow marker instruction includes a parameter, wherein the parameter may correspond to valid sources of indirect flow instructions based on source markers. For example, the indirect flow instruction is a valid source if the source marker matches the parameter of the flow marker instruction and is an invalid source if the source marker does not match the parameter of the flow marker instruction. Embodiments include causing an exception if the indirect flow instruction is an invalid source and permitting the attempt to redirect the processing flow by the indirect flow instruction if the indirect flow instruction is a valid source. These and other details will be discussed in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

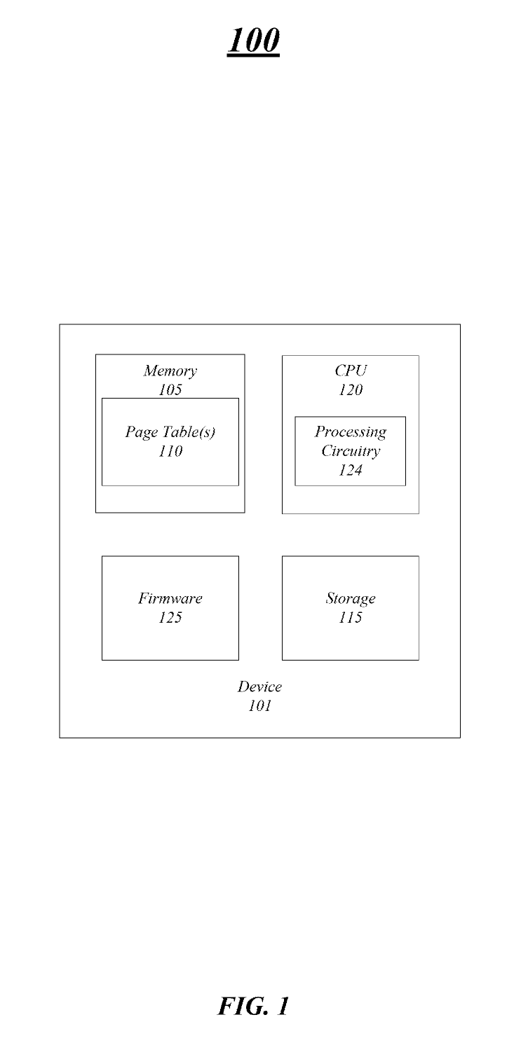

FIG. 1 illustrates an example embodiment of a system 100 in which aspects of the present disclosure may be employed to prevent control flow attacks. The system 100 may include a device 101 having a number of components, circuitry, and infrastructure to detect an attempt of an indirect flow instruction to redirect a process flow from an invalid source instruction and take corrective actions to prevent control flow attacks.

In various embodiments, the device 101 may be embodied as any type of computing device, including a personal computing, a desktop computer, a tablet computer, a netbook computer, a notebook computer, a laptop computer, a server, server farm, blade server, or any other type of server, and so forth. In some embodiments, the device 101 may be a communication station, a mobile station, an advanced station, a client, a platform, a wireless communication device, a mobile computer, a set-top box, a handheld computer, a handheld device, a Personal Digital Assistant (PDA) device, a handheld PDA device, netbook, a mobile telephone, a smart phone, a mobile cellular telephone, and so forth. In some embodiments, the device 101 may include memory 105 which may include page table(s) 110, storage 115, and a computing processing unit (CPU) 120 having processing circuitry 124. Embodiments are not limited in this manner.

In embodiments, the memory 105 may be one or more of volatile memory including random access memory (RAM) dynamic RAM (DRAM), static RAM (SRAM), double data rate synchronous dynamic RAM (DDR SDRAM), SDRAM, DDR1 SDRAM, DDR2 SDRAM, SSD3 SDRAM, single data rate SDRAM (SDR SDRAM), and so forth.

Embodiments are not limited in this manner, and other memory types may be contemplated and be consistent with embodiments discussed herein. For example, the memory 105 may be a three-dimensional crosspoint memory device, or other byte addressable write-in-place nonvolatile memory devices. In embodiments, the memory devices may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin-transfer torque (STT)-MRAM, a spintronic magnetic junction memory based device, a magnetic tunneling junction (MTJ) based device, a DW (Domain Wall) and SOT (Spin-Orbit Transfer) based device, a thyristor-based memory device, or a combination of any of the above, or other memory.

As mentioned, the memory 105 may have page tables 110 having a number of pages with page table entries. The page tables 110 may provide mappings between virtual addresses and physical addresses. The mappings may be used to locate information in the memory 105 (or a different memory/storage). Note that in some embodiments, the page tables 110 or portions thereof may be in different memory, such as cache. As will be discussed in more detail, each of the page table entries may have a mapping to a physical memory address and a source marker to identify an instruction associated with a page table entry. The source marker may be used to determine whether the instruction is a valid source or invalid source for a redirection processing flow, for example.

In embodiments, the device 101 may include storage 115. Storage 115 may be implemented as a non-volatile storage device such as, but not limited to, a disk drive, an internal storage device, an attached storage device, flash memory, battery backed-up SDRAM (synchronous DRAM), and a network accessible storage device

In some embodiments, the device 101 may include one or more CPUs 120 which each may include one or more cores and processing circuitry 124 to process information for the device 101. The CPU 120 may be one or more of any type of computational element, such as but not limited to, a microprocessor, a processor, central processing unit, digital signal processing unit, dual-core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. In some embodiments, the CPU 120 may be connected to and communicate with the other elements of the computing system via one or more interconnects, such as one or more buses, control lines, and data lines.

In embodiments, the processing circuitry 124 includes elements that may provide protection against redirection flow attacks, such as call/jmp-oriented programming attacks (COP/JOP) which may try to divert the control flow instructions from an original target address to a new target address and problems generated by call/jmps dispatching to multiple targets, such as end branch instructions. In embodiments, the processing circuitry 124 may execute one or more instructions that may be incorporated in memory and storage as firmware 125 to prevent these attacks as discussed herein. In some embodiments, the firmware 125 may be updateable (flashed), and in other instances, the firmware 125 may be set at the time of manufacturer of the device 101 or a component incorporated in the device 101 and cannot be changed.

In some embodiments, the processing circuitry 124 may perform a number of operations to prevent these redirection flow attacks. For example, the processing circuitry 124 may detect an attempt of an indirect flow instruction to redirect processing flow. More specifically, the processing circuitry 124 may determine that a call instruction (CALL) or jump instruction (JMP) is executing or about to be executed and is attempting to redirect processing flow to another instruction or set of instructions. For example, a call instruction may redirect processing flow to a function. The function may include a set of instructions, the first of which may be a flow marker instruction, such as an endbranch instruction (ENDBR32 or ENDBR64). If the flow marker instruction of the redirection is not an endbranch instruction, an exception may be generated.

In embodiments, the processing circuitry 124 may determine that the flow marker instruction includes or accepts a parameter. For example, an endbranch instruction may accept a parameter that may be used to identify a valid source or invalid source of the indirect flow instruction. In some embodiments, the parameter may be one or more bits that may be used as an identifier of valid sources. The one or more bits may be generated by an operating system including a compiler and a loader when configuring a page table for the functions including the indirect flow instructions and the flow marker instructions. The operating system may determine which and how many bits are used as source markers and parameters, for example. In some embodiments, the operating system may utilize extended option tables in binary formats, such as the executable and linking format (ELF) table and the portable executable table, to determine the source markers that are used to identify a source or indirect flow instruction.

For valid sources, the one or more bits of the parameter may correspond to one or more bits in a page table entry for the indirect flow instruction when the indirect flow instruction is valid and is not generated for an attack. As will be discussed in more detail, the page table entry for the instruction may include an address for the instruction in memory, control bits, and one or more bits used as a source marker. The one or more bits used as a source marker may be reserved bits of a page table entry. Thus, for a valid indirect flow instruction, the source marker in the page table entry for the indirect flow instruction may correspond to the parameter of the recipient instruction. For an invalid indirect flow instruction, the parameter of the recipient instruction and the source marker may not correspond or match.

The processing circuitry 124 may cause an exception if the indirect flow instruction is an invalid source for the recipient instruction, e.g. the attempt to redirect the processing flow may be prevented, an error may be generated, and other corrective actions may be executed. Moreover, the controller 130 may permit the attempt to redirect the processing flow by the indirect flow instruction if the indirect flow instruction is a valid source for the recipient instruction.

In embodiments, the processing circuitry 124 may enable backward capability for function or instruction sets that do not include recipient instructions, e.g. endbranch instructions, which do not accept parameters. In some instances, the controller 130 determines that the recipient instruction does not accept or is not coded to receive a parameter. For example, legacy function or instruction sets may include endbranch instructions that are not coded to accept a parameter, e.g. have zero bits used as a parameter. In these instances, the processing circuitry 124 may permit the indirect flow instruction to redirect the processing flow without causing an exception and determining whether a source marker corresponds to a parameter. In these embodiments, a level of protection is still provided by the utilization of the flow marker or target instructions themselves, e.g. endbranch instructions. An attempt to redirect to an instruction other than an endbranch instruction will cause an exception, for example.

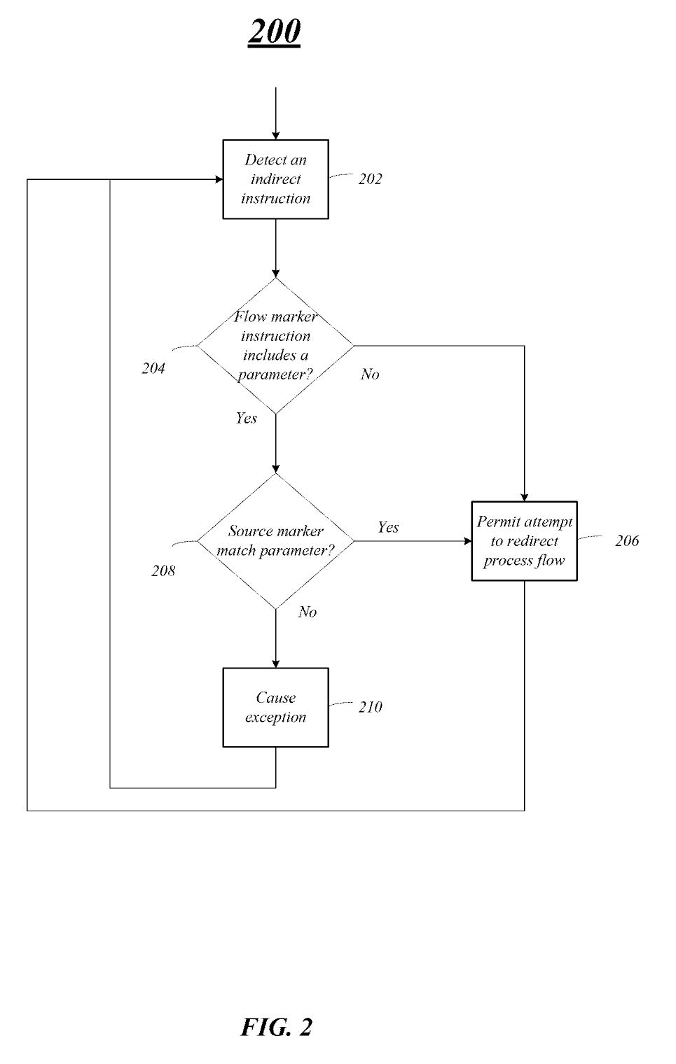

FIG. 2 illustrates one embodiment of a first logic flow 200. The logic flow 200 may be representative of some or all the operations executed by one or more embodiments described herein. Further, the logic flow 200 may perform by circuitry and one or more components discussed herein, such as the CPU 120 and processing circuitry 124. Note that some embodiments, one or more operations may be performed by other elements of a system, and embodiments are not limited in this manner. Moreover, logic flow 200 may be performed in conjunction with one or more other logic flows discussed herein and lists particular steps occurring in a particular order. However, embodiments are not limited in this manner.

The logic flow 200 may be one example flow to prevent redirection attacks. In embodiments, the logic flow 200 may include detecting an attempt of an indirect flow instruction to redirect processing flow at block 202. More specifically, the controller 120 may determine that a call instruction (CALL) or jump instruction (JMP) is executing or about to be executed and is attempting to redirect processing flow to another instruction or set of instructions. For example, a call instruction may redirect processing flow to a function block to perform one or more functions or operations. The function block may include a set of instructions, the first of which may be the flow marker instruction, such as an endbranch instruction (ENDBR32 or ENDBR64). If the recipient instruction of the redirection is not an endbranch instruction, an exception may be generated.

At block 204, the logic flow may include determining that the flow marker instruction of the attempt to redirect includes or can receive a parameter. For example, an endbranch instruction may accept a parameter that may be used to identify whether the indirect flow instruction is a valid source or invalid source. In some embodiments, the parameter may be one or more bits that may be used as an identifier of valid sources. The one or more bits may be generated or determined by an operating system including loader when creating page table entries.

In some embodiments, if the flow marker instruction does not include a parameter (or zero bits as a parameter) at block 204, the system may include support for legacy function blocks. For example and at block 206, embodiments may include permitting the attempt to redirect the process flow to the flow marker instruction and corresponding function block. If the flow marker instruction includes a parameter at block 204, the logic flow 200 may include determining whether a source marker for the indirect flow instruction matches or corresponds to the parameter of the flow marker instruction at block 208. For valid sources, the one or more bits of the parameter of the flow marker instruction may correspond to one or more bits in a page table entry for the indirect flow instruction, for example. For an invalid source, the indirect flow instruction may not include a source marker or may include a source marker that does not correspond to the parameter of the flow marker instruction.

Embodiments may include permitting the attempt to redirect the processing flow by the indirect flow instruction at block 206 if the source marker for the indirect flow instruction corresponds to the parameter of the flow marker instruction. However, embodiments may include causing an exception at block 210 if the indirect flow instruction is an invalid source for the flow marker instruction, e.g. the attempt to redirect the processing flow may be prevented, an error may be generated, and other corrective actions may be executed.

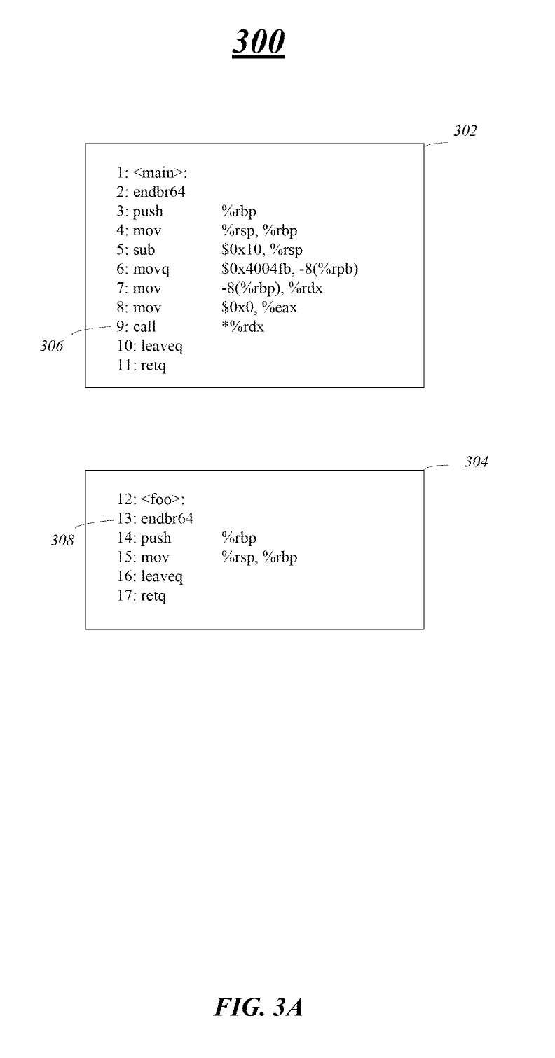

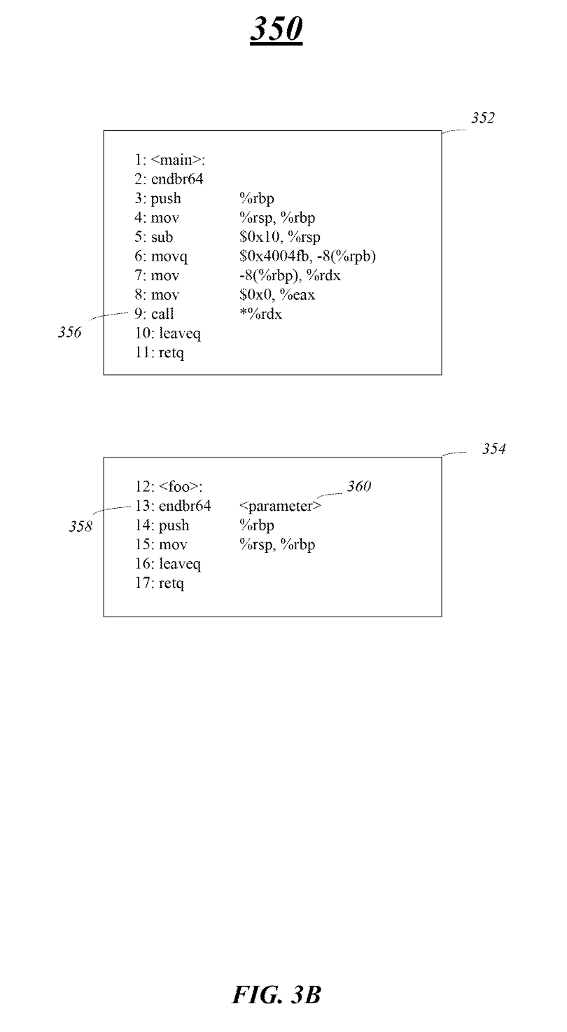

FIGS. 3A/3B illustrates an example of function blocks 300 and 350 having instructions that may be used by way of example to discuss embodiments herein. Embodiments are not limited to these function blocks 300 and 350.

In one example, the function blocks 300 illustrated in FIG. 3A illustrate an example of instructions in a legacy format, e.g. an endbranch instruction that has zero bits for a parameter. Function block 302 includes a number of assembly instructions that perform operations. At line 9 of function block 302, the indirect flow instruction 306, e.g. the call instruction, may call the function of function block 304. The flow marker instruction 308, e.g. the endbranch instruction, of function block 304 may be the first instruction processed based on the indirect flow instruction 306. As illustrated in FIG. 3A, the flow marker instruction 308 does not have any bits for a parameter. Thus, in this illustrated example of FIG. 3A, the indirect flow instruction 306 may be permitted to redirect the processing flow to the function block 304 and function thereof. As previously discussed, this illustrated embodiment of FIG. 3A may support legacy or prior instructions.

FIG. 3B illustrates another example including function block 352 and function block 354. As similarly discussed above in FIG. 3A, the indirect flow instruction 356 at line 9 of function 352 may call the function of function block 354. The flow marker instruction 358 may receive the function call. However, in the illustrated example of FIG. 3B, the flow marker instruction 358 may include a parameter 360, which may be one or more bits that may be used to identify a valid source for indirect flow instructions. More specifically, the parameter 360 may correspond with a source marker in page table entry for the indirect flow instruction 356 if the indirect flow instruction 356 is a valid source. Alternatively, the parameter 360 may not correspond with a source marker in a page table entry for the indirect flow instruction 356 if the indirect flow instruction 356 is not a valid source. Embodiments are not limited to the examples illustrated in FIGS. 3A and 3B. For example, different indirect flow instructions and recipient instructions may be utilized.

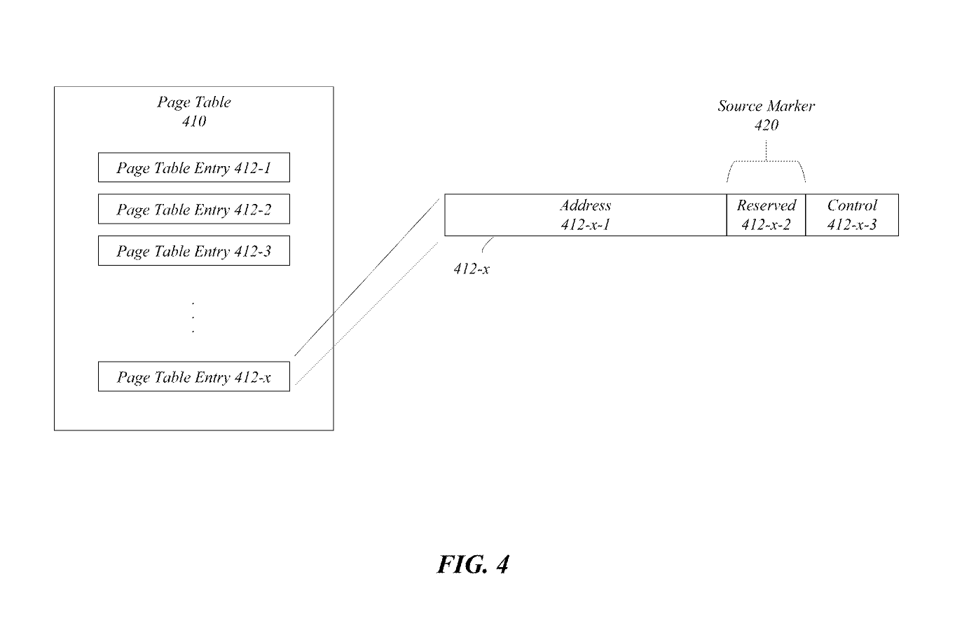

FIG. 4 illustrates an example of a page table 410, which may be similar a page table previously discussed in FIG. 1. For example, the page table 410 may provide mappings between virtual addresses and physical addresses. The mappings may be used to locate information in memory. The page table 410 may include a number of page table entries 412-x, where x may be any positive integer. Each of the page table entries 412 may correspond to an instruction that may be executed on a system or device. For example, a page table entry 412 may correspond to an instruction and provide a mapping for the instruction such that information may be received from memory based on an address in the page table entry 412.

Each of the page table entries may have a number of bits that may be used to perform a look up in memory, determine a source marker for an instruction, and provide control bits. By way of example, page table 412-x includes address bits 412-x-1, reserved bits 412-x-2, and control bits 412-x-3. The address bits 412-x-1 may include an address in memory that may be used to perform an instruction. The reserve bits 412-x-2 may be one or more bits and may be used as a source marker 420 for the corresponding instruction. In some embodiments, the number of bits may be determined by an operating system loading code, for example. In the example, three (3) bits may be used as a source marker 420. Thus, in this example, eight (8) source markers may be used, e.g. 000 through 111 in binary. The control bits 412-x-3 may include a global page bit, a page size bit, an access bit, a cache disabled bit, a write-through bit, a user/supervisor bit, a read/write bit, and a present bit. Embodiments are not limited in this manner.

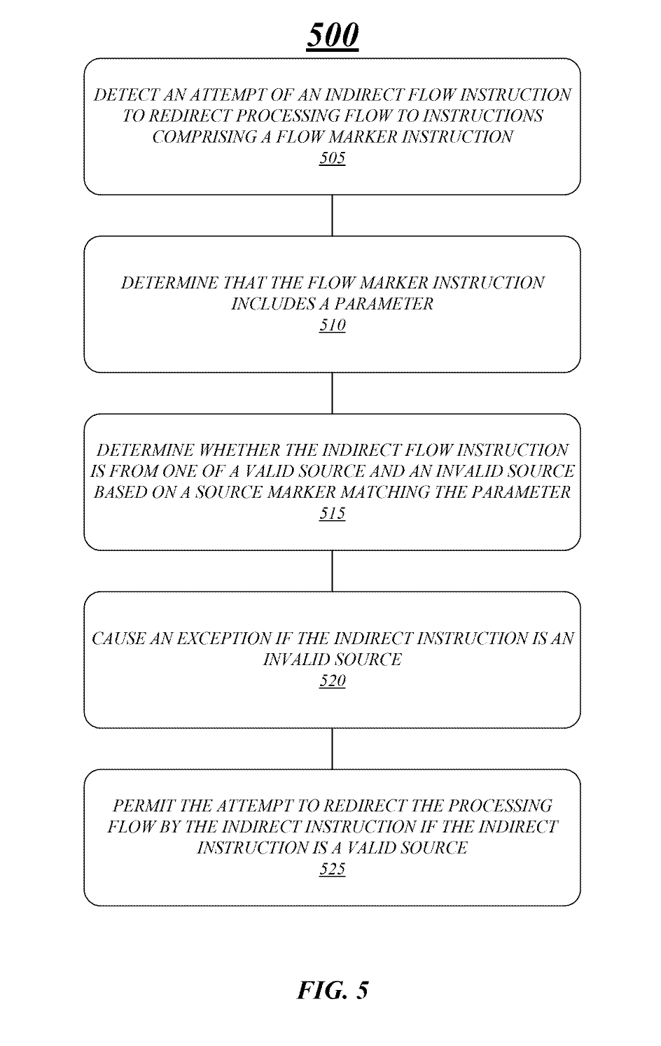

FIG. 5 illustrates an example of a second processing flow 500 to prevent redirection attacks. The processing flow 500 may be representative of some or all of the operations executed by one or more embodiments described herein. For example, the processing flow 500 may illustrate operations performed by device 101, including controller 130 and CPU 120.

At block 505, the logic flow 500 may include detecting an attempt of an indirect flow instruction to redirect processing flow to instructions comprising a flow marker instruction. For example, embodiments may include determining that a call instruction (CALL) or jump instruction (JMP) is executing or about to be executed and is attempting to redirect processing flow to another instruction or set of instructions that include a flow marker instruction. The processing flow may be a sequence of instructions that are executed by a device or system. In one example, a process flow may be the flow through executing an instruction in order. A redirection of a processing flow may be when a call or jump instruction redirects to a different function block or instruction than the next instruction in a current function block. Embodiments are not limited in this manner.

At block 510, the logic flow 500 may include determining that the flow marker instruction includes a parameter. In some embodiments, the flow marker instruction may be an endbranch instruction that may be at the beginning of a set of instructions or function block to which the call instruction or jump instruction are redirecting. At block 515, the logic flow may include determining whether the indirect flow instruction is from one of a valid source and an invalid source based on a source marker matching the parameter. The source marker may be one or more bits in a page table entry for the indirect flow instruction. The indirect flow instruction is a valid source if the source marker corresponds to the parameter of the recipient instruction. Alternatively, the indirect flow instruction is an invalid source if the source marker does not correspond to the parameter of the recipient instruction. Further and at block 520, the logic flow 500 includes causing an exception if the indirect flow instruction is an invalid source. At block 525, the logic flow 500 includes permitting the attempt to redirect the processing flow by the indirect flow instruction if the indirect flow instruction is a valid source.

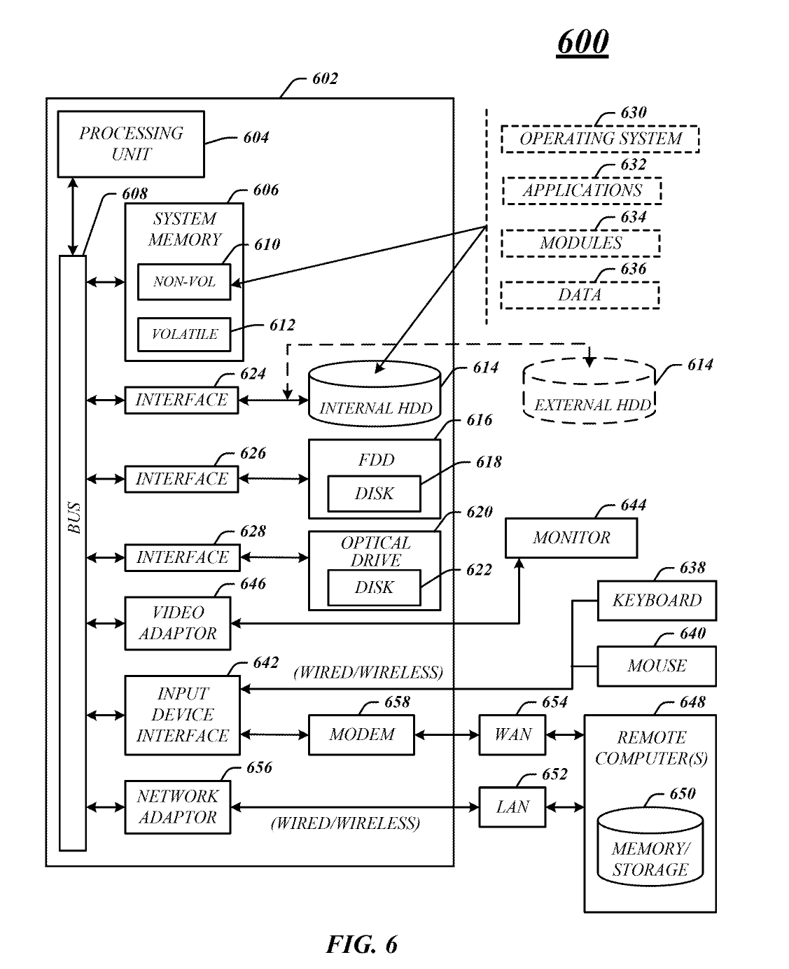

FIG. 6 illustrates an embodiment of an exemplary computing architecture 600 suitable for implementing various embodiments as previously described. In embodiments, the computing architecture 600 may include or be implemented as part of device 100, for example.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and thread of execution, and a component can be localized on one computer and distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 includes a processing unit 604, a system memory 606 and a system bus 608. The processing unit 604 can be any of various commercially available processors.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by an HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and components of the system 700.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and larger networks, for example, a wide area network (WAN) 654. Such LAN and WAN networking environments are commonplace in offices and companies and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 602 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the device 100 and 600 as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

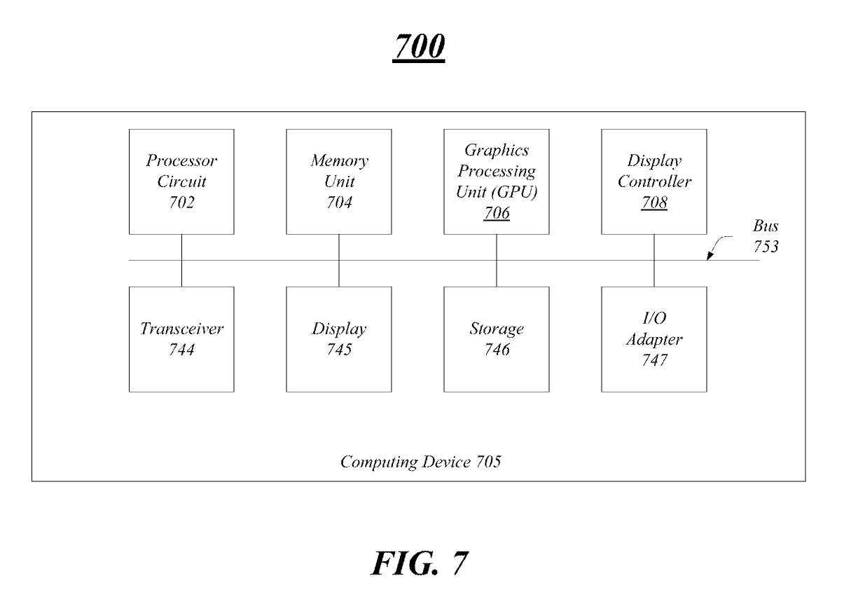

FIG. 7 illustrates one embodiment of a system 700. In various embodiments, system 700 may be representative of a system or architecture suitable for use with one or more embodiments described herein, such as device 100.

As shown in FIG. 7, system 700 may include multiple elements. One or more elements may be implemented using one or more circuits, components, registers, processors, software subroutines, modules, or any combination thereof, as desired for a given set of design or performance constraints. Although FIG. 7 shows a limited number of elements in a certain topology by way of example, it can be appreciated that more or less elements in any suitable topology may be used in system 700 as desired for a given implementation. The embodiments are not limited in this context.

In various embodiments, system 700 may include a computing device 705 which may be any type of computer or processing device including a personal computer, desktop computer, tablet computer, netbook computer, notebook computer, laptop computer, server, server farm, blade server, or any other type of server, and so forth.

Examples of a computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

In various embodiments, computing device 705 may include processor circuit 702. Processor circuit 702 may be implemented using any processor or logic device. The processing circuit 702 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 702 may be connected to and communicate with the other elements of the computing system via an interconnect 743, such as one or more buses, control lines, and data lines.

In one embodiment, computing device 705 may include a memory unit 704 to couple to processor circuit 702. Memory unit 704 may be coupled to processor circuit 702 via communications bus 743, or by a dedicated communications bus between processor circuit 702 and memory unit 704, as desired for a given implementation. Memory unit 04 may be implemented using any machine-readable or computer-readable media capable of storing data, including both volatile and non-volatile memory. In some embodiments, the machine-readable or computer-readable medium may include a non-transitory medium. The embodiments are not limited in this context.

Computing device 705 may include a graphics processing unit (GPU) 706, in various embodiments. The GPU 706 may include any processing unit, logic or circuitry optimized to perform graphics-related operations as well as the video decoder engines and the frame correlation engines. The GPU 706 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 706 may process any type of graphics data such as pictures, videos, programs, animation, 3D, 2D, objects images and so forth.

In some embodiments, computing device 705 may include a display controller 708. Display controller 708 may be any type of processor, controller, circuit, logic, and so forth for processing graphics information and displaying the graphics information. The display controller 708 may receive or retrieve graphics information from one or more buffers. After processing the information, the display controller 708 may send the graphics information to a display.

In various embodiments, system 700 may include a transceiver 744. Transceiver 744 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 744 may operate in accordance with one or more applicable standards in any version. The embodiments are not limited in this context.

In various embodiments, computing device 705 may include a display 745. Display 745 may constitute any display device capable of displaying information received from processor circuit 702, graphics processing unit 706 and display controller 708.

In various embodiments, computing device 705 may include storage 746. Storage 746 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 746 may include technology to increase the storage performance enhanced protection for valuable digital media when multiple hard drives are included, for example. Further examples of storage 746 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 705 may include one or more I/O adapters 747. Examples of I/O adapters 747 may include Universal Serial Bus (USB) ports/adapters, IEEE 1374 Firewire ports/adapters, and so forth. The embodiments are not limited in this context.

The detailed disclosure now turns to providing examples that pertain to further embodiments. Examples one through thirty-two (1-32) provided below are intended to be exemplary and non-limiting.

In a first example, a system, a device, an apparatus, and so forth may include processing circuitry to prevent redirection attacks, and a memory storing instructions operable on the processing circuitry, the instructions, when executed, cause the processing circuitry to detect an attempt of an indirect flow instruction to redirect processing flow to instructions comprising a flow marker instruction. The processing circuitry may determine that the flow marker instruction includes a parameter, determine whether the indirect flow instruction is from one of a valid source and an invalid source based on a source marker matching the parameter, cause an exception if the indirect flow instruction is an invalid source, and permit the attempt to redirect the processing flow by the indirect flow instruction if the indirect flow instruction is a valid source.

In a second example and in furtherance of the first example, a system, a device, an apparatus, and so forth may include the processing circuitry to determine that the flow marker instruction does not include the parameter, and permit the attempt to redirect the processing flow by the indirect flow instruction.

In a third example and in furtherance of the previous examples, a system, a device, an apparatus, and so forth may include the processing circuitry to process the flow marker instruction comprising an endbranch instruction, and wherein the indirect flow instruction comprises one of a call instruction and a jump instruction.

In a fourth example and in furtherance of the previous examples, a system, a device, an apparatus, and so forth may include the processing circuitry to determine the indirect flow instruction is from the valid source if the source marker matches the parameter.

In a fifth example and in furtherance of the previous examples, a system, a device, an apparatus, and so forth may include processing circuitry to determine the indirect flow instruction is from the invalid source if the source marker does not match the parameter.

In a sixth example and in furtherance of the previous examples, a system, a device, an apparatus, and so forth may include the processing circuitry to process the source marker comprising one or more bits of a page table entry for the indirect flow instruction.

In a seventh example and in furtherance of the previous examples, a system, a device, an apparatus, and so forth may include processing circuitry to process the source marker including the one or more bits comprising reserved bits corresponding to the page table entry for the indirect flow instruction.

In an eighth example and in furtherance of the previous examples, a system, a device, an apparatus, and so forth may include a storage to store an operating system, the operating system to determine a number of bits corresponding to a page table entry for the indirect flow instruction to use to determine whether the indirect flow instruction is from the valid source or the invalid source.

In a ninth example and in furtherance of the previous examples, a method may include detecting an attempt of an indirect flow instruction to redirect processing flow to instructions comprising a flow marker instruction, determining that the flow marker instruction includes a parameter, determining whether the indirect flow instruction is from one of a valid source and an invalid source based on a source marker matching the parameter, causing an exception if the indirect flow instruction is an invalid source, and permitting the attempt to redirect the processing flow by the indirect flow instruction if the indirect flow instruction is a valid source.

In a tenth example and in furtherance of the previous examples, a method may include determining that the flow marker instruction does not include the parameter, and permitting the attempt to redirect the processing flow by the indirect flow instruction.

In an eleventh example and in furtherance of the previous examples, a method may include processing the flow marker instruction comprises an endbranch instruction, and wherein the indirect flow instruction comprises one of a call instruction and a jump instruction.

In a twelfth example and in furtherance of the previous examples, a method may include determining the indirect flow instruction is from the valid source if the source marker matches the parameter.

In a thirteenth example and in furtherance of the previous examples, a method may include determining the indirect flow instruction is from the invalid source if the source marker does not match the parameter.

In a fourteenth example and in furtherance of the previous examples, a method may include processing the source marker comprising one or more bits of a page table entry for the indirect flow instruction.

In a fifteenth example and in furtherance of the previous examples, a method may include processing the source marker wherein the one or more bits comprising reserved bits corresponding to the page table entry for the indirect flow instruction

In a sixteenth example and in furtherance of the previous examples, a method may include determining a number of bits corresponding to a page table entry for the indirect flow instruction to use to determine whether the indirect flow instruction is from the valid source or the invalid source.

In a seventeenth example and in furtherance of the previous examples, a non-transitory computer-readable storage medium, comprising a plurality of instructions, that when executed, enable processing circuitry to detect an attempt of an indirect flow instruction to redirect processing flow to instructions comprising a flow marker instruction, determine that the flow marker instruction includes a parameter, determine whether the indirect flow instruction is from one of a valid source and an invalid source based on a source marker matching the parameter, cause an exception if the indirect flow instruction is an invalid source, and permit the attempt to redirect the processing flow by the indirect flow instruction if the indirect flow instruction is a valid source.

In an eigtheenth example and in furtherance of the previous examples, a non-transitory computer-readable storage medium, comprising a plurality of instructions, that when executed, enable processing circuitry to determine that the flow marker instruction does not include the parameter, and permit the attempt to redirect the processing flow by the indirect flow instruction.

In a ninteenth example and in furtherance of the previous examples, a non-transitory computer-readable storage medium, comprising a plurality of instructions, that when executed, enable processing circuitry to process the flow marker instruction comprising an endbranch instruction, and wherein the indirect flow instruction comprises one of a call instruction and a jump instruction.

In a tweneith example and in furtherance of the previous examples, a non-transitory computer-readable storage medium, comprising a plurality of instructions, that when executed, enable processing circuitry to determine the indirect flow instruction is from the valid source if the source marker matches the parameter.

In a twenty-first example and in furtherance of the previous examples, a non-transitory computer-readable storage medium, comprising a plurality of instructions, that when executed, enable processing circuitry to determine the indirect flow instruction is from the invalid source if the source marker does not match the parameter.

In a twenty-second example and in furtherance of the previous examples, a non-transitory computer-readable storage medium, comprising a plurality of instructions, that when executed, enable processing circuitry to process the source marker comprising one or more bits of a page table entry for the indirect flow instruction.

In a twenty-third example and in furtherance of the previous examples, a non-transitory computer-readable storage medium, comprising a plurality of instructions, that when executed, enable processing circuitry to process the source marker including the one or more bits comprising reserved bits corresponding to the page table entry for the indirect flow instruction.

In a twenty-fourth example and in furtherance of the previous examples, a non-transitory computer-readable storage medium, comprising a plurality of instructions, that when executed, enable processing circuitry to determine a number of bits corresponding to a page table entry for the indirect flow instruction to use to determine whether the indirect flow instruction is from the valid source or the invalid source.

In a twenty-fifth example and in furtherance of the previous examples, a system, a device, an apparatus, and so forth may include means for detecting an attempt of an indirect flow instruction to redirect processing flow to instructions comprising a flow marker instruction, means for determining that the flow marker instruction includes a parameter, means for determining whether the indirect flow instruction is from one of a valid source and an invalid source based on a source marker matching the parameter, means for causing an exception if the indirect flow instruction is an invalid source, and means for permitting the attempt to redirect the processing flow by the indirect flow instruction if the indirect flow instruction is a valid source.

In a twenty-sixth example and in furtherance of the previous examples, a system, a device, an apparatus, and so forth may include means for determining that the flow marker instruction does not include the parameter, and means for permitting the attempt to redirect the processing flow by the indirect flow instruction.

In a twenty-seventh example and in furtherance of the previous examples, a system, a device, an apparatus, and so forth may include means to process the flow marker instruction comprises an endbranch instruction, and wherein the indirect flow instruction comprises one of a call instruction and a jump instruction.

In an twenty-eighth example and in furtherance of the previous examples, a system, a device, an apparatus, and so forth may include for determining the indirect flow instruction is from the valid source if the source marker matches the parameter.

In a twenty-ninth example and in furtherance of the previous examples, a system, a device, an apparatus, and so forth may include for determining the indirect flow instruction is from the invalid source if the source marker does not match the parameter.

In a thirtieth example and in furtherance of the previous examples, a system, a device, an apparatus, and so forth may include means for processing the source marker comprising one or more bits of a page table entry for the indirect flow instruction.

In a thirty-first example and in furtherance of the previous examples, a system, a device, an apparatus, and so forth may include means for processing the one or more bits comprising reserved bits corresponding to the page table entry for the indirect flow instruction.

In a thirty-second example and in furtherance of the previous examples, a system, a device, an apparatus, and so forth may include means for determining a number of bits corresponding to a page table entry for the indirect flow instruction to use to determine whether the indirect flow instruction is from the valid source or the invalid source.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
processing circuitry;
a memory storing instructions operable on the processing circuitry, the instructions, when executed, cause the processing circuitry to:
detect an attempt of an indirect flow instruction to redirect processing flow to instructions comprising a flow marker instruction;
determine that the flow marker instruction includes a parameter;
determine whether the indirect flow instruction is from one of a valid source and an invalid source based on a source marker matching the parameter;
cause an exception if the indirect flow instruction is the invalid source; and
permit the attempt to redirect the processing flow by the indirect flow instruction if the indirect flow instruction is the valid source.

2. The apparatus of claim 1, the processing circuitry to:
determine that the flow marker instruction does not include the parameter; and
permit the attempt to redirect the processing flow by the indirect flow instruction.

3. The apparatus of claim 1, wherein the flow marker instruction comprises an endbranch instruction, and wherein the indirect flow instruction comprises one of a call instruction and a jump instruction.

4. The apparatus of claim 1, the processing circuitry to determine the indirect flow instruction is from the valid source if the source marker matches the parameter.

5. The apparatus of claim 1, processing circuitry to determine the indirect flow instruction is from the invalid source if the source marker does not match the parameter.

6. The apparatus of claim 1, the source marker comprising one or more bits of a page table entry for the indirect flow instruction.

7. The apparatus of claim 6, the one or more bits comprising reserved bits corresponding to the page table entry for the indirect flow instruction.

8. The apparatus of claim 1, comprising a storage to store an operating system, the operating system to determine a number of bits corresponding to a page table entry for the indirect flow instruction to use to determine whether the indirect flow instruction is from the valid source or the invalid source.

9. A computer-implemented method, comprising:
detecting an attempt of an indirect flow instruction to redirect processing flow to instructions comprising a flow marker instruction;
determining that the flow marker instruction includes a parameter;
determining whether the indirect flow instruction is from one of a valid source and an invalid source based on a source marker matching the parameter;
causing an exception if the indirect flow instruction is the invalid source; and
permitting the attempt to redirect the processing flow by the indirect flow instruction if the indirect flow instruction is the valid source.

10. The computer-implemented method of claim 9, comprising:
determining that the flow marker instruction does not include the parameter; and
permitting the attempt to redirect the processing flow by the indirect flow instruction.

11. The computer-implemented method of claim 9, wherein the flow marker instruction comprises an endbranch instruction, and wherein the indirect flow instruction comprises one of a call instruction and a jump instruction.

12. The computer-implemented method of claim 9, comprising determining the indirect flow instruction is from the valid source if the source marker matches the parameter.

13. The computer-implemented method of claim 9, comprising determining the indirect flow instruction is from the invalid source if the source marker does not match the parameter.

14. The computer-implemented method of claim 9, the source marker comprising one or more bits of a page table entry for the indirect flow instruction.

15. The computer-implemented method of claim 14, the one or more bits comprising reserved bits corresponding to the page table entry for the indirect flow instruction.

16. The computer-implemented method of claim 9, comprising determining a number of bits corresponding to a page table entry for the indirect flow instruction to use to determine whether the indirect flow instruction is from the valid source or the invalid source.

17. A non-transitory computer-readable storage medium, comprising a plurality of instructions, that when executed, enable processing circuitry to:
detect an attempt of an indirect flow instruction to redirect processing flow to instructions comprising a flow marker instruction;
determine that the flow marker instruction includes a parameter;
determine whether the indirect flow instruction is from one of a valid source and an invalid source based on a source marker matching the parameter;
cause an exception if the indirect flow instruction is the invalid source; and
permit the attempt to redirect the processing flow by the indirect flow instruction if the indirect flow instruction is the valid source.

18. The non-transitory computer-readable storage medium of claim 17, comprising a plurality of instructions, that when executed, enable processing circuitry to:
determine that the flow marker instruction does not include the parameter; and
permit the attempt to redirect the processing flow by the indirect flow instruction.

19. The non-transitory computer-readable storage medium of claim 17, wherein the flow marker instruction comprises an endbranch instruction, and wherein the indirect flow instruction comprises one of a call instruction and a jump instruction.

20. The non-transitory computer-readable storage medium of claim 17, comprising a plurality of instructions, that when executed, enable processing circuitry to determine the indirect flow instruction is from the valid source if the source marker matches the parameter.

21. The non-transitory computer-readable storage medium of claim 17, comprising a plurality of instructions, that when executed, enable processing circuitry to determine the indirect flow instruction is from the invalid source if the source marker does not match the parameter.

22. The non-transitory computer-readable storage medium of claim 17, the source marker comprising one or more bits of a page table entry for the indirect flow instruction.

23. The non-transitory computer-readable storage medium of claim 22, the one or more bits comprising reserved bits corresponding to the page table entry for the indirect flow instruction.

24. The non-transitory computer-readable storage medium of claim 17, comprising a plurality of instructions, that when executed, enable processing circuitry to determine a number of bits corresponding to a page table entry for the indirect flow instruction to use to determine whether the indirect flow instruction is from the valid source or the invalid source.
